(19) United States
(12) Patent Application Publication
(10) Pub. No.: US 2011/0089130 A1
(43) Pub. Date: Apr. 21, 2011

(54) Synthetic Cable as a Carrying Means for Cranes and other Hoists

(76) Inventor: Volker Stephan, Wittmund (DE)

(21) Appl. No.: 12/901,828

(22) Filed: Oct. 11, 2010

(30) Foreign Application Priority Data
Oct. 16, 2009 (DE) 20 2009 014 031.8

(51) Int. Cl. B66C 23/82

(52) U.S. Cl. 212/262

(57) ABSTRACT

The invention relates to a device for vertically lifting a load, preferably a crane, comprising a base, at least one jib extending out from the base, at least one cable which is guided from the base around the tip of the jib, at least one device for gripping or securing a load which is attached or can be attached to the end of the cable guided around the tip of the jib, wherein the cable is a synthetic cable.

### CROSS-REFERENCE TO PRIOR APPLICATION

This application is a Paris Convention filing under 35 U.S.C. §119 and claims priority to and benefit from German Utility Model Application DE 20 2009 014 031.8, filed on Oct. 16, 2009, and hereby incorporates such application herein in its entirety.

### TECHNICAL FIELD

The invention relates to a device for vertically lifting a load, preferably a crane or some other hoist. The load is lifted by means of a cable and the cable is a synthetic cable.

### BACKGROUND OF THE INVENTION

The use of synthetic cables in numerous applications is already known. The further the development of such cables progresses, the broader the range of applications in which they can be used becomes. Their low weight and high strength compared with steel cables in particular make synthetic cables especially suitable for use as safety cables in sport, medical applications and technical textile products. Synthetic cables have long been used in the field of sports and with lifesaving equipment. In more recent times, however, synthetic cables have also been used for industrial purposes, for example for towing ships into harbour, for commercial fishing, in forestry and for laying cables. Synthetic cables have proved to be particularly practical for laying underwater cables because they float on the water surface and are therefore not able to become tangled in the ship's propeller. The low intrinsic weight of a synthetic cable advantageously reduces the transport weight on board and the weight which has to be pulled in when reeling them in. Another advantage of synthetic cables is that if conditioned accordingly, they are more resistant to aggressive salt water than conventional steel cables.

### SUMMARY

An objective of the invention is to propose a device for vertically lifting a load.

This objective is achieved by means of a device as defined in claim 1.

The device proposed by the invention is a device for vertically lifting a load, preferably a crane. The crane may be a mobile crane which is mounted on a vehicle or a known construction crane which can be transported and erected. However, the device may also be fixedly mounted on or in a building or a frame and lift and lower an elevator or passenger lift. The expression vertically lifting within the scope of the invention is also intended to mean a linear pulling action parallel with an inclined plane, for example the movement of a ski lift, a cable car or a lift on a mountainside.

### DETAILED DESCRIPTION

The device has a base and a jib extending out from the base. The device also has a cable, which is guided from the base around the tip of the jib, and a device for gripping or securing a load, which is attached to or can be attached to the end of the cable guided around the tip of the jib. The cable is a synthetic cable.

It is preferable if the jib can be moved relative to the base. Accordingly, it can be pivoted upwards or downwards relative to the base or can be rotated relative to the base about an axis of rotation extending essentially perpendicular to the base surface. It is also possible for the base to rotate jointly with the jib about a common axis of rotation. The jib may also be of a telescopic design.

The synthetic cable is preferably a cable made from HMPE or HPPE fibres. However, the invention is not restricted to the use of these specific synthetic fibres and instead, also includes the use of other synthetic fibres which have the same or similar properties to those mentioned above.

From the group of HMPE (High Modulus Polyethylene) materials, synthetic fibres can be produced which are able to float on water, have excellent properties as regards abrasion, bending and tensile strength as well as having one of the best resistances to UV light from among the synthetic fibres. HMPE fibres have a chemical structure which is comparable with that of normal polyethylene but with a far higher molecular weight and a far higher crystallinity.

The cable may have a sheath, in which case the cable and sheath may be made from the same synthetic fibre or the sheath may be made from a different synthetic or plastic fibre from the cable itself. The latter option may be selected in particular if the sheath is required to exhibit certain properties such as sliding ability, abrasion strength, resistance to light or a fluorescent surface, for example, which can not be obtained using the synthetic fibre used to make the cable or can be so but only at a cost.

It may also be of practical advantage if the sheath is of a different colour, regardless of whether it is made from the same material as or a different material from the cable. In this respect, the sheath itself may in turn have different layers of differing colours. This makes it possible to tell whether there is any abrasion on the cable simply by looking, for example. If the cable can be seen underneath the sheath or a preferably signal-coloured layer of the sheath becomes visible, this may be an indication that the cable needs to be replaced.

Additional fibres of a different material may be braided or woven into the cable itself, for example a metal or non-metal material. These might be glass fibres, carbon fibres or copper fibres for example, which improve certain properties such as the tensile or bending strength of the cable. In particular, metal or other electrically conductive fibres may also be used to test the integrity of the cable. For example, such a fibre may extend across the entire length of the cable and may have a beginning and an end which can be connected to a measuring device. It can then be ascertained by means of the measurement whether the current conducting fibre is intact or perhaps broken, which, in the latter case, may be an indication that the cable has been overstretched or subjected to some other damage, making it necessary to replace the synthetic cable.

In order to prevent the use of counterfeit synthetic cables, anti-counterfeit codes may be woven into the cable, containing details of the manufacturer, the date of manufacture and an expiry date, for example, which can be scanned or read by means of an electronic device, similar to the codes used on foodstuffs and items of clothing. However, the code may also be pigmentation for example, which can be detected by special lamps or viewing devices and authenticate the product.

The colour design of the sheath and the cable without sheath may also be based on the corporate identity of the user and may incorporate the company colours of the manufacturer or user, for example.

The fibres making up the synthetic cable or making up part of it may be covered with a coating or finish in order to improve the resistance of the synthetic fibres in particular to environmental influences, such as cold (icing), moisture and sunlight.

It is preferable if the density of the synthetic cable is equal to or less than 1.5 kg/dm³, and even more preferably, the density is equal to or less than 1 kg/dm³. The synthetic cable should have a diameter of at most 80 mm, preferably a diameter of at most 30 mm to 60 mm.

Since the synthetic cable can replace the steel cable used in a crane, for example, it is preferable in such situations if the synthetic cable is of essentially the same diameter as the steel cable which it replaces. As a result, all the guide rollers and other cable guiding parts of the crane do not have to be changed, which makes the replacement of steel cables with synthetic cables economically attractive since no additional costs will be incurred for replacing the cable guiding parts.

However, in the case of a device, for example a crane, specially built for the use of synthetic cables, this does not mean that materials that are not optimally adapted to the synthetic cables can be used on surfaces on which the synthetic cable runs (for example pulley blocks). The dimensions of the cable guiding parts and the material from which they are made are adapted to the use of synthetic cables in the case of such new devices, which makes the device lighter overall than a device built for use with steel cables.

Since the synthetic cable intended to satisfy the same requirements as a steel cable is rated differently from steel cable in terms of diameter and has different winding properties, the device may preferably have a winch or several winches which is or are especially suited to winding synthetic cables. Such winches might be specially adapted double capstan winches or drum winches with smaller diameters than would be needed for steel cables of the same cable length, and thus of a lesser weight.

At 7.85 kg/dm³, the density of steel corresponds to approximately 8 times the density of a preferred synthetic cable. For a cable length of 290 m, for example, this corresponds to a difference in weight of approximately 600 kg. Due to the lower intrinsic weight of the cable and other possible weight advantages due to lighter cable drums, the ultimate load of the device can advantageously be increased.

In or next to the base, the device has a drive unit which is coupled with or can be coupled with the cable drum or drums and by means of which the synthetic cable can be wound onto the cable drum and unwound from the cable drum.

Another advantage of synthetic fibres is that they are easier to handle than steel cables due to their low weight and, unlike steel cable, pose no risk of injury to personnel due to projecting “meat hooks”, for example when suspending a load. Due to their low intrinsic weight, they reduce the risk of injury overall during deployment.

1. A device for vertically lifting a load, preferably a crane, comprising
a) a base,
b) at least one jib extending out from the base,
c) at least one cable which is guided from the base around the tip of the jib,
d) at least one device for gripping or securing a load which is attached or can be attached to the end of the cable guided around the tip of the jib,
e) the cable is a synthetic cable.

2. The device for vertically lifting a load as claimed in claim 1, wherein said jib can be moved relative to the base and/or jointly with the base.

3. The device for vertically lifting a load as claimed in claim 1, wherein said synthetic cable is made from HMPE fibres.

4. The device for vertically lifting a load as claimed in claim 1, wherein said cable has a sheath and said cable and sheath are made from the same synthetic fibres.

5. The device for vertically lifting a load as claimed in claim 1, wherein said sheath is made from a different synthetic or plastic fibre than the cable.

6. The device for vertically lifting a load as claimed in claim 1, wherein said sheath is of a different colour than the synthetic cable and abrasion of the sheath at one point at least indicates that the synthetic cable needs to be replaced.

7. The device for vertically lifting a load as claimed in claim 1, wherein fibres of a different metal or non-metal material are additionally woven into the synthetic cable.

8. The device for vertically lifting a load as claimed in claim 1, wherein said additional fibres are glass fibres, carbon fibres or copper fibres.

9. The device for vertically lifting a load as claimed in claim 1, wherein further including at least one additional current conducting fibre connected to a measuring device in order to ascertain due to a measurement whether there is any break in the fibre, and a break in the fibre may be an indication of overstretching or some other damage, for example due to bending of the synthetic cable.

10. The device for vertically lifting a load as claimed in claim 1, further including an anti-counterfeit code woven into said synthetic fibre cable.

11. The device for vertically lifting a load as claimed claim 1, wherein at least the synthetic fibres are covered with a coating or finish.

12. The device for vertically lifting a load as claimed in claim 1, wherein the density of said synthetic cable is equal to or less than 1 kg/dm³.

13. The device for vertically lifting a load as claimed in claim 1, further including a winch for winding and unwinding said cable, and said winch is specifically suitable for winding synthetic cables.

14. The device for vertically lifting a load as claimed in claim 1, wherein said synthetic cable has a diameter of at most 80 mm.

15. The device for vertically lifting a load as claimed in claim 1, wherein said synthetic cable has a diameter of 30 mm to 60 mm.

16. A crane for vertically lifting a load, comprising:
a base unit;
at least one jib extending outward from said base unit;
a cable extending from said base and guided from said base unit outward around a tip of said jib;
a device connected to said cable and operable to secure said cable to a load, said cable extending around said jib;
said cable being a synthetic cable having a conductive fiber woven extending along at least a portion of said cable length, said conductive fiber capable of providing a signal indicating the integrity of said synthetic cable;
wherein said conductive fiber woven in said synthetic cable can be stretched with said synthetic cable.

17. The crane for vertically lifting a load as claimed in claim 16 wherein said conductive fiber is electrically connected to a measuring device, said measuring device providing signals indicating status of said conductive fiber.

18. The crane for vertically lifting a load as claimed in claim 17 wherein said status of said fiber includes broken, discontinuous or overstretched.

19. A crane for vertically lifting an object, comprising:
a base and a jib extending out from said base;
a cable guided from said base by a plurality of guide rollers around a tip of said jib said jib movable relative to said base;
said cable made of at least a portion of high modulous polyethylene and surrounded by a sheath; and,
wherein said cable has a density of less than about 1.5 kg/dm³ and a diameter of less than about 80 mm.
